(19) United States
(12) Patent Application Publication
(10) Pub. No.: US 2011/0320244 A1
(43) Pub. Date: Dec. 29, 2011

(54) Pre-Paid Customer Reward Card

(76) Inventor: Corrie Dontia McCoy, San Diego, CA (US)

(21) Appl. No.: 12/822,533

(22) Filed: Jun. 24, 2010

(51) Int. Cl. G06Q 30/00

(52) U.S. Cl. 705/14.1; 705/39

(57) ABSTRACT

This invention relates to a plastic card, wallet size, equipped with magnetic strip to store customer information; the card will be labeled with identifying logos from the source of travel and with identifying information pertaining to the customer or owner of the card. The card is designed to be used to purchase modes of travel i.e., tickets from a selected source of travel, such as, but not limited to, planes, trains, automobiles, buses, boats and ships. This card is loaded by the customer with cash to be redeemed at any time for purchasing tickets and other services provided by their source/s of travel. The concept benefits the consumer; reduction in the use of credit cards and a opportunity to save on high interest rates. For the merchant/card issuer; the earned interest on pre-paid balances increases liquidity and enhances investment opportunities.

### BACKGROUND

In light of times where there are economic uncertainties, customers make efforts to reduce their use of credit, thereby, affecting the decline in the travel economic industry. Simultaneously, creditors are penalizing customers by closing their accounts or reducing their credit limits without notice due to lack of activity or purchases after a certain period of time. Not to mention, there are high fees and changing credit terms, to increase their revenue as a result of the cautious customer. Customers are paying two, three and more times the credit that was extended to them and being penalized for losing the ability to pay back according to the terms offered to them in the beginning or having to prioritize their distribution of payments to creditors.

Unexpected events occur, despite credit available balances and a customer's ability to access cash otherwise. With a pre-paid rewards card, the customer can rest assured that should such an event occur, i.e. a family illness or death, that they will have the ability to purchase a source of traveling abroad or to the family member without questioning the resources they have available to use without altering the family's budget.

Prices are constantly changing and deals and price-cuts from various sources of travel are limited and sporadic. Often times customers, hope to take advantage of such deals but the offers may not coincide with their current financial obligations. Having a card that has been pre-paid over a period time will allow the customer to use their available balance to take advantage of the offers immediately when they become available.

Family vacations and annual events are standard for most families and can be very expensive. Having a card that the family can pay into will assist the family with staying on a budget and still taking time to get away. Customers no longer have to make finance charged purchases to earn points or rewards.

Currently sources of travel, i.e. source of travels and other travel sources have reward or frequent flyer cards that are suppose to reward the customers and frequent flyers. Credit card companies and banks have also implemented reward points. The rewards are not cost effective and over time the customer has ultimately paid for the reward through purchases and/or various fees and interest by the time they can redeem their points. Customers are typically rewarded between $0.01 and $0.05 for every dollar they spend. For example, a customer will have to spend nearly four thousand dollars just to redeem one four hundred dollar airline or cruise ship ticket.

Regardless of the use of the card, travel merchants can offer their customers rewards that they can redeem before their travel such as but not limited to discounted prices. In addition, the customer is also offered rewards that can be redeemed during their travel, such as no fees for baggage check-in, on-board purchases, coffee coupons during layovers, magazines, books, or items from gift shops or other airport vendors, store owners, or franchise owners. The customer is also offered rewards that can be redeemed after their travel, such as but not limited to cancellation insurances, no-cost for change in reservations, or other applicable or fee based services.

### BRIEF DESCRIPTION OF THE DRAWINGS

FIG. 1 is an embodiment of the front of the card, which contains the source of travel logo and the customer's identifying information;

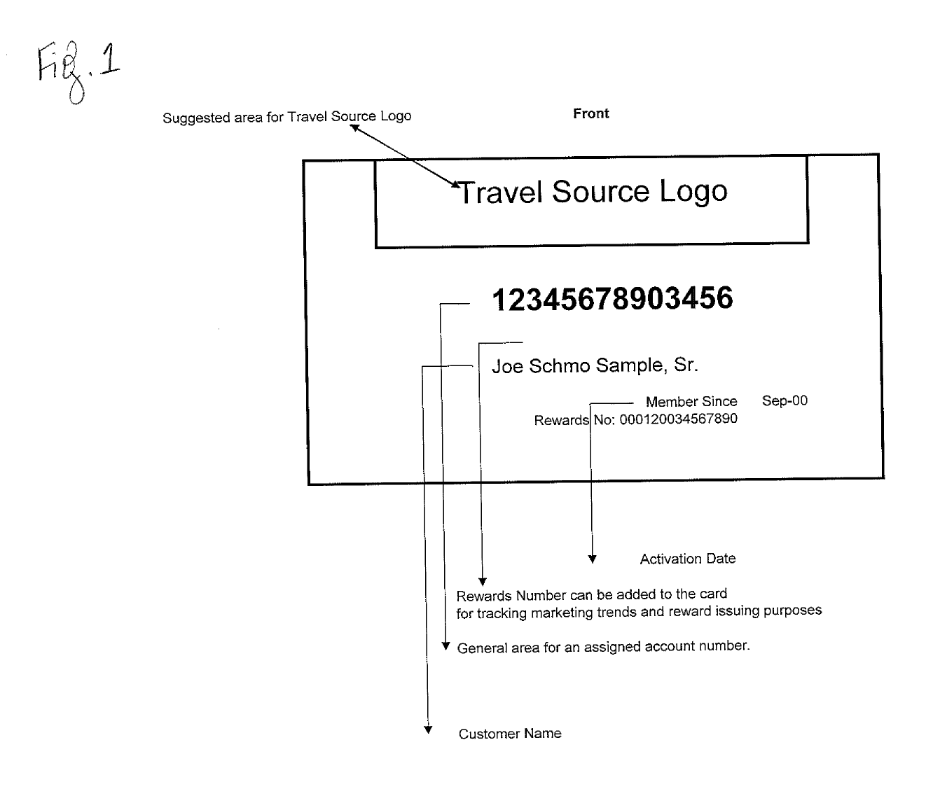

FIG. 2 is an embodiment of the back of the card, which contains the signature of the customer/owner of the card with an optional photo for added security; and

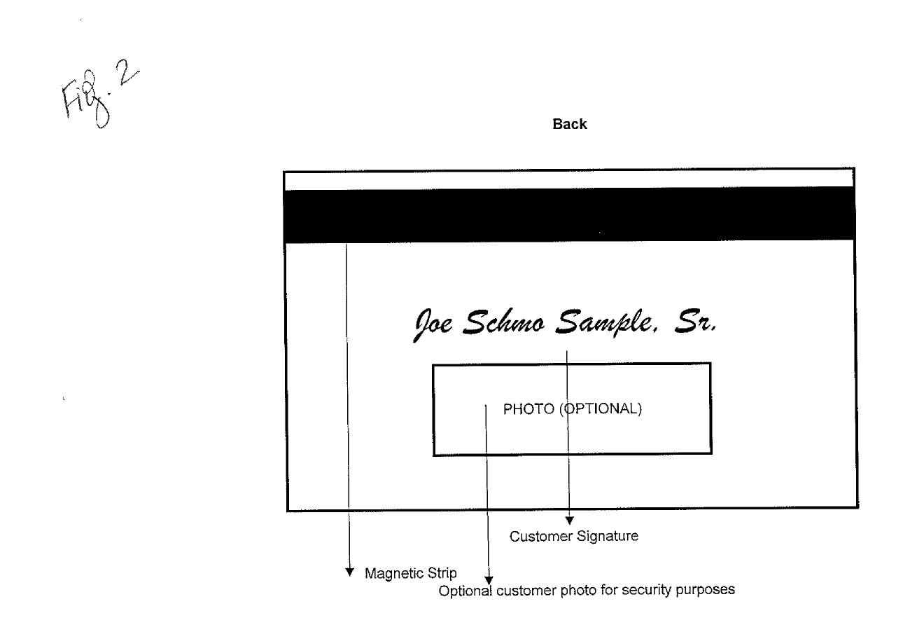

FIG. 3 is a flow chart for a process of the uses of an embodiment of the card.

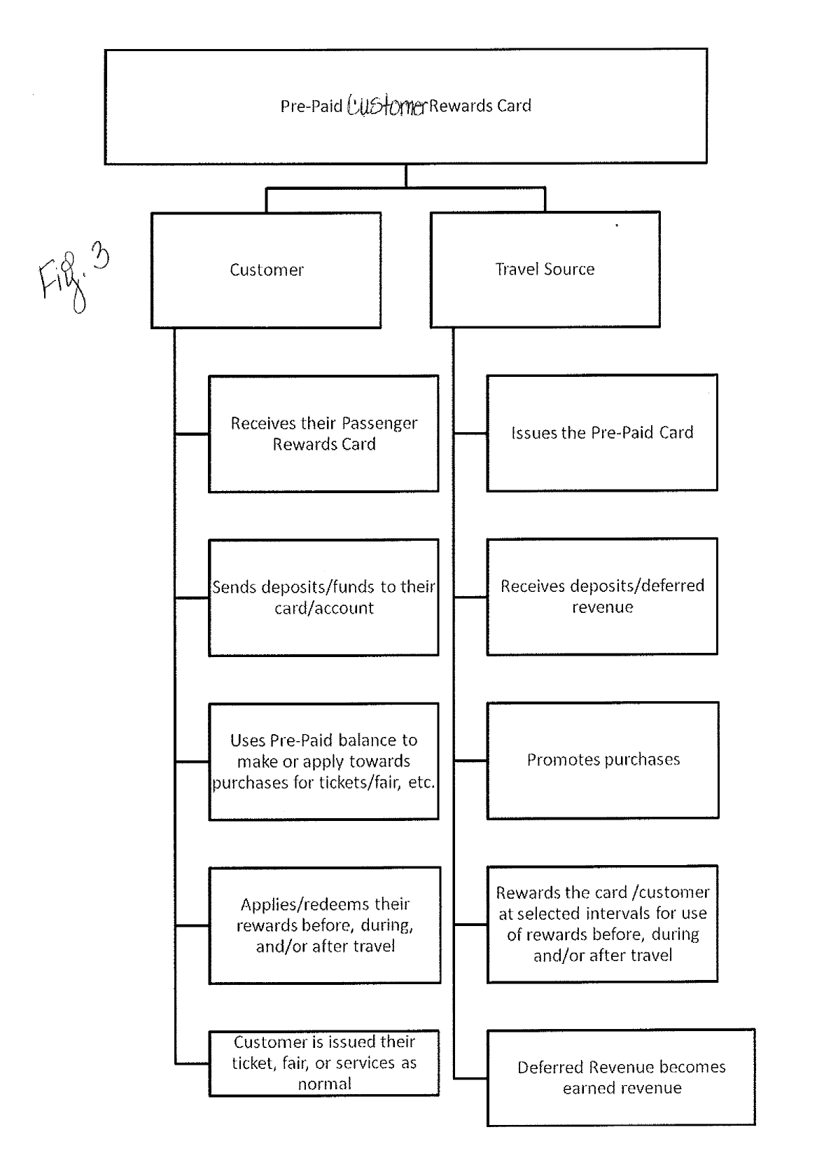

FIG. 4 is a sample chart of the merchant or types of companies that would best benefit from the process or use of the card or the offer of the card to their customers

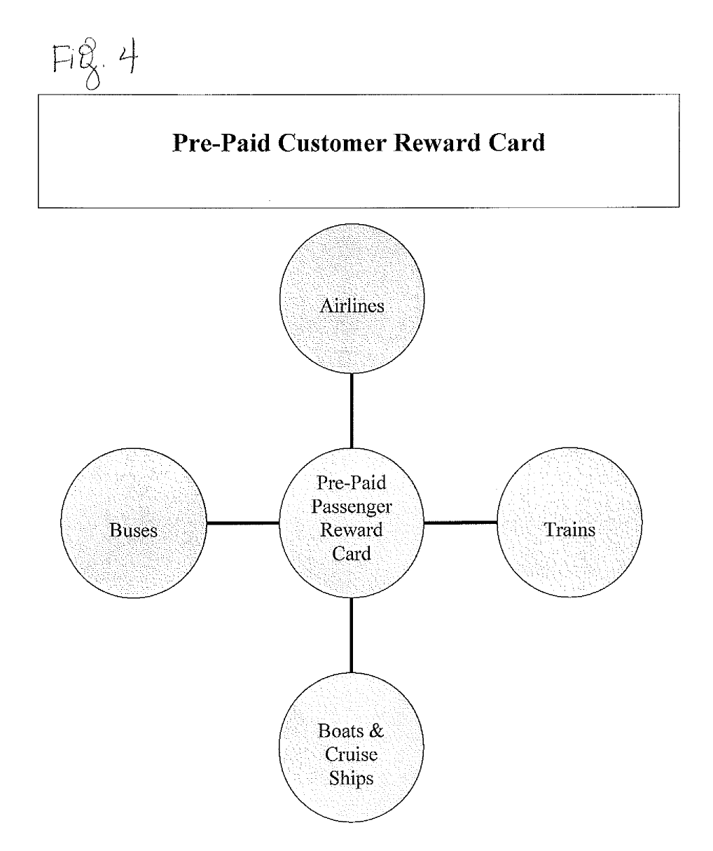

### DETAILED DESCRIPTION

The preferred embodiment and other embodiments, including the best mode of carrying out the invention, are hereby described in detail with reference to the drawings. Further embodiments, features and advantages will become apparent from the ensuing description or may be learned without undue experimentation. The figures are not drawn to scale, except where otherwise indicated. The following description of embodiments, even if phrased in terms of “the invention,” is not to be taken in a limiting sense, but describes the manner and process of making and using the invention. The coverage of this patent will be described in the claims. The order in which steps are listed in the claims does not indicate that the steps must be performed in that order.

The present invention relates to a pre-paid customer reward card.

In an embodiment of the invention, issued cards have the ability to have cash loaded onto them through the card provider. As planned and unexpected events occur the passenger and/or customer will have reserved cash to be used without effecting their family budget and expenses.

In an embodiment of the invention, pre-paying or depositing funds to a card exclusively for the selected source of travel and/or place of destination eliminates credit card fees to both the customer and the card provider. This advanced feature to their new or existing reward or frequent flyers card will assist passengers and/or customers in a weak economy and reserve revenue in the form of cash to offset the increasing fuel prices and low economic spending. The cash and the savings on fee's can be invested and increase liquidity in the business.

In an embodiment of the invention, a pre-paid reward card includes the following elements; a card, in the size of a wallet photo. The use of the card must be restricted to the issuer of the card. The rewards are based on the terms of the merchant, determined by but not limited to the travel habits of the customer and redeemable during travel time.

An embodiment of this invention includes a pre-paid card issued by a source for use restricted to the services provided by the issuer. This card is issued by the source and managed according to their terms of issuance. This card may be issued and managed by a third party of the source but visibly recognized with, as or through the primary merchant and their designs, logos or trade markings. This is a card, made up of the same elements as a credit card, offered exclusively by the source or merchant directly to the customer.

In an embodiment, the card is not transferable between sources of travel not owned or pre-authorized by the issuer or terms holder of the card. This card is used for and/or during all things travel related. For example, credit cards can be used nationwide, with any merchant, where they are accepted. This restriction makes the use of the card's balance exclusive to the issuer of the card for reason's mentioned in [Paragraph's 9 & 10].

Qualified customers are issued a card that is re-loadable without limit or expiration of use, in accordance with the terms between the customer and the issuer of the card. The customer is issued a card with their Name, Account Number, and/or rewards number. Expiration date is optional to the preference of the card issuer. The customer is then authorized to send cash increments to their card to be held as an available balance to purchase services from that source of travel, i.e. tickets and/or any extended services, at will, and/or within the terms between the customer and the source of travel.

An embodiment of the invention is used in the same manner as a “credit” card, except the balance is completely pre-paid and available to the customer without “credit” related obligations. The source of travel or its preferred outside source or third party, would maintain the entire cycle of processing the customer databases and transactions therein.

An embodiment of the card is the same shape or components of a credit card or gift card. The source or merchant will issue, distribute and maintain the card as they do their reward cards, Name, account numbers, and possibly photos of the card holder will be on the card, linked to the owner of the card. The account number tracks the deposits, purchases and travel habits of the customer for use and marketing purposes.

In an embodiment of the invention, the source, merchant or corporation will establish a process for receiving, recording and managing customer funds both tangibly and intangibly. Tangibly to mean as viewed through physical receipt of the payment, the deposit, and the destination of the funds and intangibly to mean as viewed on customer statements, financial statements, and other internal processes for managing the customers account.

In an embodiment of the invention, the source, merchant or corporation will collaborate with their bank or otherwise to establish and link each card for receipt of funds. When the customer has deposited enough funds to the card and they are ready to make their purchase, the funds are transferred to a designated bank account of the source, merchant or corporation; the card balance is reduced, and similar to other purchases the customer has secured their reservations with their selected destination.

Loading/depositing funds to the card can be initiated by the customer, through the selected source of travel, by mailing a check or other acceptable forms of payment through the mail. The customer, once issued the card, is authorized to send cash increments to their card to be held as an available balance to purchase modes of travel fare/tickets and/or any extended services of the source of travel, at will, and/or within the terms between the customer and the source of travel.

Funds deposited by mail; any negotiable instrument, i.e. check or money order, that can be drawn against, to pay a specified amount of money to a specific person upon demand, can be mailed to the source of travel and credited to the customer's account creating an available balance for the customer to purchase tickets or other services provided by the source of travel.

Electronic payments/transfers of funds from the customer's bank account, or other funding streams to the card can be initiated at will or set up on regular intervals as preferred by the customer. The source of travel will then receive the funds/transaction to be credited to the appropriate account to reflect the customer's available prepaid balance.

The card is owned, produced, and issued by the source of travel, or their outside source of production and/or distribution, to be used exclusively for the purchase of tickets, and/or any extended services of the source of travel, in lieu of or in addition to other forms of payment.

Various other collaborations can be developed to deposit funds to the card in regular or irregular increments.

What is claimed is:

1. A method of purchasing comprising:
providing a card that identifies a purchaser;
depositing funds to and in association with the card;
making purchases related to travel using the funds in a manner restricted by the issuer of the card; and
providing rewards to pre-paid users to include but not limited to travel miles, discounted rates, on-board purchases, airport vendor discounts, etc. to the purchaser.

2. A device comprises:
a card;
a. Wherein the card can be used to purchase modes of travel i.e. tickets and/or services.
b. The card balance consists of pre-payments by the customer and/or reward balances on the card
c. The card is restricted to use of the services provided by the card issuer
d. The method as in claim 1 wherein the pre-paid reward card identifies the purchaser with the purchaser's name.
e. The method as in claim 1 wherein the customer of the pre-paid reward card makes incremental deposits for future purchases and redeems rewards with out increased use of credit.

3. Sources of Travel mentioned throughout;
a. for example, but not limited to, planes, trains, automobiles, buses, boats and ships.
